(19) United States
(12) Patent Application Publication
(10) Pub. No.: US 2018/0361513 A1
(43) Pub. Date: Dec. 20, 2018

(54) SYSTEM AND METHOD OF MINIMIZING WELD DISTORTION USING PNEUMATIC VIBRATION

(71) Applicant: Advanced VSR Technology LLC, Philadelphia, PA (US)

(72) Inventor: Bruce Klauba, Philadelphia, PA (US)

(73) Assignee: Advanced VSR Technology LLC, Philadelphia, PA (US)

(21) Appl. No.: 16/060,773

(22) PCT Filed: Dec. 9, 2016
(86) PCT No.: PCT/US16/65895

§ 371 Date: Jun. 8, 2018

Related U.S. Application Data
(60) Provisional application No. 62/265,070, filed on Dec. 9, 2015.

(51) Int. Cl. B23K 31/00; B23K 9/025; B23K 9/22

(52) U.S. Cl. CPC B23K 31/003; B23K 9/22; B23K 9/025

(57) ABSTRACT

A new technique in welding is provided that utilizes vibration during the welding process. The technique requires a pneumatic control panel having a master pneumatic input and dual pneumatic outputs. Each pneumatic output powers a pneumatic vibrator arranged in a particular orientation with respect to the weldment. The vibrators may be arranged such that the axes of rotation of the vibrators are orthogonal to the vector of the weld seam. The vibrators are set using the pneumatic control panel to vibration frequencies that are out of phase sufficient to form a beat frequency in the weldment. The weld produced when the welding occurs during this vibration yields less distortion and stronger and more predictable welds.

### REFERENCE TO RELATED APPLICATIONS

This application is claims priority to U.S. Provisional Patent Application Ser. No. 62/265,070 filed Dec. 9, 2015, the disclosure of which is hereby incorporated by reference.

### FIELD OF DISCLOSURE

One or more embodiments of the one or more present inventions relate to the use of three dimensional vibration during welding (“3D-VDW”) to reduce distortion that occurs during welding.

### BACKGROUND

For decades, vibration has been used in an attempt to reduce/minimize welding distortion, with a very checkered and inconsistent history of success.

Some progress has been made when the concept of sub-resonance was brought to light. With this method, the vibrator excitation speed is adjusted not at or upon resonance, but slightly lower, so that some boost of vibration amplitude is achieved, but less so than if tuned directly upon resonance. The supposed modus operandi of this method is that the mechanical hysteresis is greatest at sub-resonance, and thus this is the most effective vibrator speed to use to achieve the desired effect.

The realities of performing welding upon a large structure, that is prone to distortion as the welding takes place, indicate that sub-resonance is, at best, a partial solution. An undeniable fact about the resonance frequency as welding continues is that: It is not constant, but rather it changes as the structure has weld-fill (metal deposited by the arc-welding process, whether the source of the added material be “stick” or “wire”) added. The amount of metal added, although significant, is nominal, compared with its effect, because it greatly stiffens the structure, as the full load-carrying capacity of the various members of the welded construction are firmly joined together. This huge increase in load-carrying capacity and stiffness/rigidity, parameters that could be considered companion factors that describe the mechanical properties of the structure, cause the resonance frequency to increase.

Thus, what might have been the proper adjustment of vibrator speed to the sub-resonance range, so to best keep welding distortion under control, quickly becomes the wrong vibrator speed to use: The vibrator speed must be increased incrementally, as the resonance frequency, and therefore also the sub-resonance frequency, grows to its final value, achieved when the welding is well-nigh complete.

In addition, there are limitations and risks, some of which involve safety, that systematically accompany using only a single electrically powered rotary vibrator as the source of vibration using a vibration-during-welding (“VDW”) process.

### SUMMARY

The present disclosure is directed to a person of ordinary skill in the art. The purpose and advantages of the disclosed methods, systems, and devices will be set forth in, and be apparent from, the drawings, description and claims that follow. The summary of the disclosure is given to aid understanding of the disclosed methods, systems, and devices, and not with an intent to limit the disclosure or the invention. It should be understood that each of the various aspects and features of the disclosure may advantageously be used separately in some instances, or in combination with other aspects and features of the disclosure in other instances. Accordingly, while the disclosure is presented in terms of embodiments, it should be appreciated that individual aspects of any embodiment can be utilized separately, or in combination with aspects and features of that embodiment or any other embodiment. In accordance with the present disclosure, variations and modifications may be made to the disclosed methods, systems, and devices to achieve different effects.

The disclosure in one or more embodiments is directed to a system and method that includes a pneumatic controller operatively connected to one or more pneumatic vibrators to provide a VDW process. More particularly, at least one embodiment provides a new technique in welding that utilizes vibration during the welding process. The technique preferably includes a pneumatic control panel having a master pneumatic input and dual pneumatic outputs. Each pneumatic output powers a pneumatic vibrator arranged in a particular orientation with respect to the weldment. The vibrators may be arranged such that the axes of rotation of the vibrators are orthogonal to the vector of the weld seam. The first vibrator may be arranged vertically perpendicular to the vector of the weld seam. The second vibrator may be arranged such that the axis of rotation is horizontally perpendicular to the vector of the weld seam. The vibrator speeds are set using the pneumatic control panel to frequencies that are out of phase sufficient to form a standing wave beat frequency in the weldment. Advantageously, the weld produced when the welding occurs during this vibration yields far less distortion. This is important in several respects. In those cases where the weldment would be subsequently machined, less “machining-stock” or excess material will need to be machined away to achieve target dimensions, thus resulting in savings in both material cost and machining time. In addition, far less corrective work is needed to straighten or align the weldment to as-welded target dimensional tolerances. Such corrective work is not only time consuming, but also can degrade the quality of the weldment, by, for example, generating additional residual stresses. Production managers at fabrication shops that regularly produce large welded structures report that between 10 to 20% of their weld-force labor is spent performing such corrective work.

In at least at one embodiment, a method for minimizing weld distortion in a weldment includes the steps of applying a first vibration frequency in a first force direction to a weldment or a welding fixture on which the weldment is attached, applying a second vibration frequency in a second force direction to the weldment or the welding fixture on which the weldment is attached, and welding the weldment along a weld seam. The first and second vibration frequencies may be selected to generate a third vibration frequency in the weldment or welding fixture and may be selected to be near but not identical to each other. The third vibration frequency may be a difference between the first and second frequencies causing a slow moving traveling wave in the weldment or welding fixture. The first and second vibration frequencies may be applied using first and second vibrators having a force output in a first and a second orthogonal direction, respectively, relative to the weld seam. The vibrators may be pneumatic vibrators. The vibration frequencies of the vibrators may be independently adjusted so that they are is near but not identical to each other. In one embodiment, the frequencies may be adjusted so that the third vibration frequency is clearly audible.

In another embodiment, a system for minimizing weld distortion may include a pneumatic control device for producing a controlling the air flow out of control device's outputs, the control device having a first and second output each for providing an output airflow intensity that may be independently variable and independently controllable to control each respective frequency output of attached vibrators; a first pneumatic vibrator attachable to a weldment or welding fixture and connectable to the first output of the pneumatic control device, wherein the first vibrator may be independently variable and independently controllable using the control device so that the first vibrator vibrates at a first vibration frequency; and a second pneumatic vibrator attachable to a weldment or welding fixture and connectable to the second output port of the pneumatic control device, wherein the second vibrator may be independently variable and independently controllable using the control device so that the second vibrator vibrates at a second vibration frequency. The first pneumatic vibrator and the second pneumatic vibrator may be arranged so that the first force direction is different than the second force direction, and wherein the first and second vibration frequencies may be selected to generate a third vibration frequency in the weldment or welding fixture. The control device may be configurable such that the first and second outputs may output first and second vibration frequencies that are near but not identical to each other. The third vibration frequency may be a difference between the first and second frequencies causing a slow moving traveling wave in the weldment or welding fixture. An air compressor may be connectable to an input on the control device.

In another embodiment, a pneumatic control device used to reduce distortion during welding may include a master input port configured to accept a connection to an air compressor; a first output port configurable to connect to a first pneumatic vibrator; a second output port configurable to connect to a second pneumatic vibrator; a selectable control interface that independently controls pneumatic input from the master input port and pneumatic output to each of the first and second output ports such that the selectable control interface has a first setting to cause the first pneumatic vibrator to vibrate at a first vibration frequency and a second setting to cause second pneumatic vibrator to vibrate at a second vibration frequency. The first and second settings may be selected to cause the first and second vibrators to generate a third vibration frequency in a weldment or welding fixture. The first and second settings may be configurable so that the first and second vibration frequencies are near but not identical to each other. The third vibration frequency may be equal to a difference between the first and second frequencies causing a slow moving traveling wave in the weldment or welding fixture.

In some embodiments, the first and second vibration frequencies may be selected to be near but not identical to each other, and wherein third vibration frequency is a difference frequency of the first and second frequencies causing a slow moving traveling wave in the weldment or welding fixture. The third vibration frequency may generate a slow moving traveling wave in the weldment or welding fixture. The distortion of the weldment or the weld seam may be reduced in part as result of sloshing or excitation, which may be caused by the third vibration frequency and/or the traveling wave, of the molten weld puddle. The distortion of the weldment or the weld seam may be reduced in part as result of a settling action, which may be caused by the third vibration frequency and/or the traveling wave, on newly formed metal grains cohering at a bottom of the molten weld puddle. The amount of weld shrinkage may be reduced as a result of compaction of the newly forming/formed metal grains caused by the settling action during cooling. The compaction of the freshly formed grains leaves less space between the grains. By reducing in size and population these millions of spaces, there is less space for these grains to rearrange during cooling, this rearranging being the cause of weld shrinkage and resulting weld distortion.

### BRIEF DESCRIPTION OF THE DRAWINGS

The various aspects, features and embodiments of the methods, systems, and devices as disclosed herein will be better understood when read in conjunction with the drawings provided. Embodiments are provided in the drawings for the purposes of illustrating aspects, features and/or various embodiments, but the claims should not be limited to the precise arrangement, structures, subassemblies, features, embodiments, aspects, methods, and devices shown, and the arrangements, structures, subassemblies, features, embodiments, aspects, methods, and devices shown may be used singularly or in combination with other arrangements, structures, subassemblies, features, embodiments, aspects, methods, and devices. The drawings are not necessarily to scale and are not in any way intended to limit the scope of the claims, but are merely presented to illustrate and describe various embodiments, aspects and features of the disclosed systems, methods, and devices to one of ordinary skill in the art.

FIG. 1 illustrates a typical arc welding set up.

FIG. 2 illustrates a dual frequency wave form exhibiting a beat frequency.

FIGS. 3A and 3B illustrate a traveling wave generated by using two vibrators set at different vibration speeds.

FIG. 4 illustrates a two vibrator set up for implementing three dimensional vibration-during-welding (“3D-VDW”).

FIG. 5 illustrates a pneumatic control panel adapted for use during 3D-VDW.

FIG. 6 illustrates pneumatic connections between the pneumatic control panel and the vibrators.

FIGS. 7A, 7B and 7C illustrates various views of welded coupons comparing the results of conventional welding and 3D-VDW.

### DETAILED DESCRIPTION

In the following detailed description, numerous details are set forth in order to provide an understanding of methods of three dimensional vibration during welding (3D-VDW). However, it will be understood by those skilled in the art that the different and numerous embodiments of the disclosed methods, systems, and devices may be practiced without these specific details, and the claims and invention should not be limited to the embodiments, subassemblies, or the specified features, methods, or details specifically described and shown herein. The description provided herein is directed to one of ordinary skill in the art and in circumstances, well-known methods, procedures, manufacturing techniques, components, and assemblies have not been described in detail so as not to obscure other aspects, or features of the disclosed methods, systems, and devices.

Accordingly, it will be readily understood that the components, aspects, features, elements, methods, and subassemblies of the embodiments, as generally described and illustrated in the figures herein, can be arranged and designed in a variety of different configurations in addition to the described embodiments. It is to be understood that the methods, systems, and devices may be used with many additions, substitutions, or modifications of form, structure, arrangement, proportions, materials, and components which may be particularly adapted to specific environments and operative requirements without departing from the spirit and scope of the invention. The following descriptions are intended only by way of example, and simply illustrate certain selected embodiments of a method of 3D-VDW.

Throughout the present application, reference numbers are used to indicate a generic element or feature of the systems and devices. The same reference number may be used to indicate elements or features that are not identical in form, shape, structure, etc., yet which provide similar functions or benefits. Additional reference characters (such as letters, primes, or superscripts, as opposed to numbers) may be used to differentiate similar elements or features from one another. It should be understood that for ease of description the disclosure does not always refer to or list all the components, and that a singular reference to an element, member, or structure may be a reference to one or more such elements, unless the context indicates otherwise.

In the following description of various embodiments of the disclosed methods, systems, and devices, it will be appreciated that all directional references (e.g., proximal, distal, upper, lower, upward, downward, left, right, lateral, longitudinal, front, rear, back, top, bottom, above, below, vertical, horizontal, radial, axial, interior, exterior, clockwise, and counterclockwise) are only used for identification purposes to aid the reader's understanding of the present disclosure unless indicated otherwise in the claims, and do not create limitations, particularly as to the position, orientation, or use in this disclosure. Features described with respect to one embodiment typically may be applied to another embodiment, whether or not explicitly indicated.

Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings may vary.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As used in this document, the term “weldment” means an assembly of two or more pieces that are to be welded together. As used herein, weldment includes the final welded assembly as well as the individual pieces prior to welding.

As used in this document, the term “welding fixture” means a fixture that is used to stabilize a weldment or the pieces thereof prior to welding.

As used in this document, the term “weld seam” means the line where the individual pieces are joined to form the weldment. Welding occurs along the weld seam.

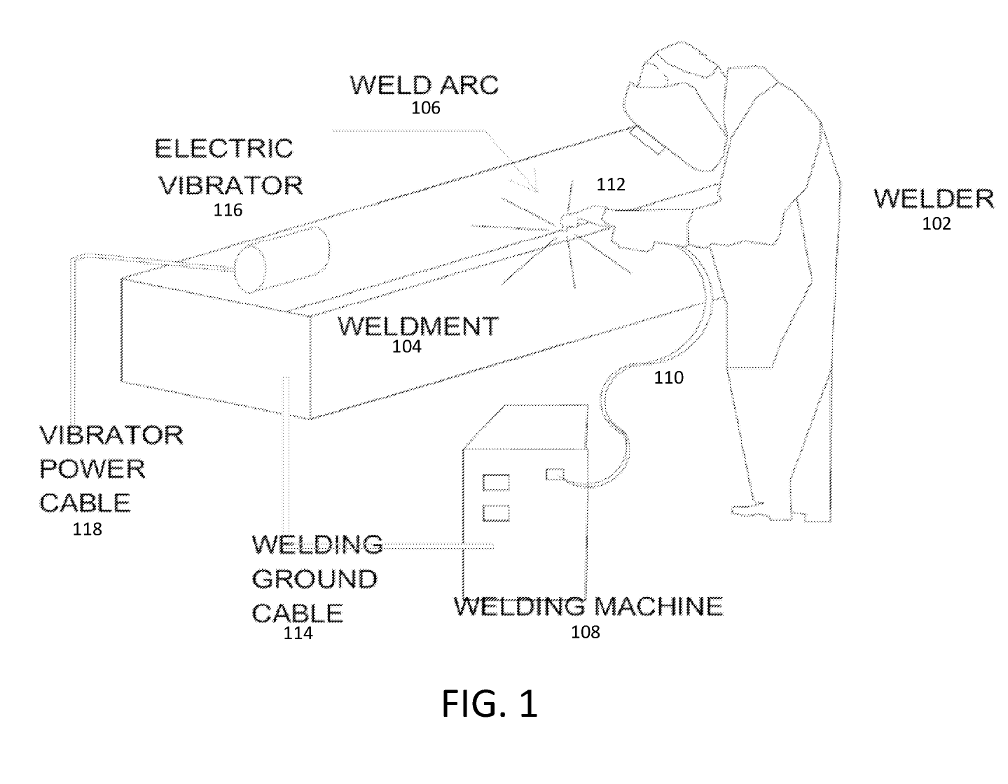

Referring to FIG. 1, a typical arc welding set up is illustrated. The welder 102 tasked with producing a weld on the weldment 104 generates a welding arc 106 using welding machine 108. Electric arc welding requires an electrical circuit, i.e., a circular conductive electrical path, the welding arc 106 being only one element of this circuit. The circuit also includes a source of electrical voltage and current, the welding machine 108, which gets its power from local alternating current (AC) power, often between 200 and 240 volts. Typically a high-current capacity cable 110 joins the welding machine 108 to the welder's tool 112, either a welding gun (through which welding wire is fed) or a clamp/holder in which is grasped a welding stick. The wire or stick are melted/consumed by the welding arc 106, and the melted material deposited, forming a “puddle” of molten material, which quickly freezes. The weldment 104 (the structure being welded) passes the current injected into it starting at the welding arc 106 and exiting at ground clamp and cable 114, which passes this current back to the welding machine 108, completing the circuit.

Using current technology, conventional vibration during welding (VDW) can be applied using a single electric powered vibrator 116, which is attached to weldment 104, or to a fixture (not shown) to which the weldment 104 is clamped. It is worth noting that both the weldment 104 and fixture are electrically conductive.

For purposes of safety, the electric motor powering the vibrator 116 also has a ground connection, through its power cable 118. In the event of a short-circuit in the motor in the vibrator 116 or vibrator power cable 118, this ground would convey potentially shocking electric potential back to the source of power feeding the vibrator 116, typically a vibrator control box (not shown). This ground through power cable 118, along with the “hot” line(s) feeding power to the vibrator 116, in the event of a short-circuit in the motor or cable, would convey excessive current, which should trigger short-circuit protection, either in the vibrator control box or a circuit breaker (not shown) feeding power to it, causing fuses to blow or a circuit breaker to trip, preventing cable burn-out and shocking potential from reaching the welder 102.

However, a different hazard, which the short-circuit protection described above is not effective in addressing, can occur if the welding ground cable 114 that the welder 102 had affixed to the weldment 104 or welding fixture is accidentally removed, disturbed, or knocked-off from its installed position. Instead of the welding current traveling through the welding ground 114 (which is no longer in the circuit), this current instead travels again through the weldment 104, but then exits through the electric vibrator's ground line 118. The vibrator's power cable does not have the ampacity (current-carrying capacity) to pass this current, and therefore will start to burn.

Short-circuit protection, whether fuses or circuit breakers, whether located in the vibrator control box or the power line feeding it, are not in this circuit. Grounds or neutrals, as declared by the National Electrical Code, Underwriters Laboratories, and other safety regulation setting institutions, are never to be passed through fuses or circuit breakers, since their continuous connection to ground is absolutely required for safe and proper short-circuit protection.

The most likely outcome of such an event (loss of welding ground 114 during electric powered VDW) would be burning of the vibrator power cable 118, since the vibrator cable 118 is most likely chosen to carry through any of its lines, approximately 20 amps at most, while the welding amperage might be ten times as large. An electric cable passing ten times its design limit will quickly heat, melt and burn the insulation around it, and possibly catch fire itself. This is the source of fires caused by overloaded electrical circuits, whether in cables, motors or other apparatus, and is the second most common cause of fires in heavy industry. See http://www.nfpa.org/research/reports-and-statistics/fires-by-property-type/industrial-and-manufacturing-facilities/fires-in-us-industrial-and-manufacturing-facilities.

Some shops and suppliers of electric VDW equipment have attempted to address this safety hazard by supplying insulating materials that can be placed between the vibrator and weldment. However, a casual placement of a tool, such as a wrench or welder's chipping hammer, lying against the vibrator and forming an electrical path to the weldment, would defeat such a plan, and might pose a greater risk of shock to the welder. The only fail safe way to remove the hazards described above is to entirely remove the electric vibrator from the system.

Another risk to an electric powered vibrator, and to the welder using it during VDW, involves the practice of pre-heating. Pre-heating, as the name implies, is the practice of raising the temperature of the weldment, often to 400 degrees F., in order to reduce the chance of cracking, reduce distortion, or avoid difficulties that occur when trying to weld materials not intended for welding, such as cast iron. Repair of cast iron or cast steel components is a common application area for pre-heating, as is the welding of low-carbon, high strength steels, high-performance (HP) steels.

Subjecting an electric motor to such temperatures is risky at best. Without extensive cooling of the motor, such as by forced air or water jacketing, the motor is at high-risk of burning out if its windings exceed much over 200 F. Such a burning motor might go unnoticed by the welder, putting him at risk for electric shock or starting a fire.

To address these safety issues, and to improve the VDW process generally, one or more embodiments of the one or more methods, systems, and devices described herein uses compressed air to operate two or more pneumatic vibrators to provide a three dimensional (3D) VDW system. By doing so, it systematically mitigates at least some of the hazards inherent in using an electric-powered vibrator to vibrate the weldment because the pneumatic vibrators do not require an electrical connection to be proximate to any welding fixture or weldment.

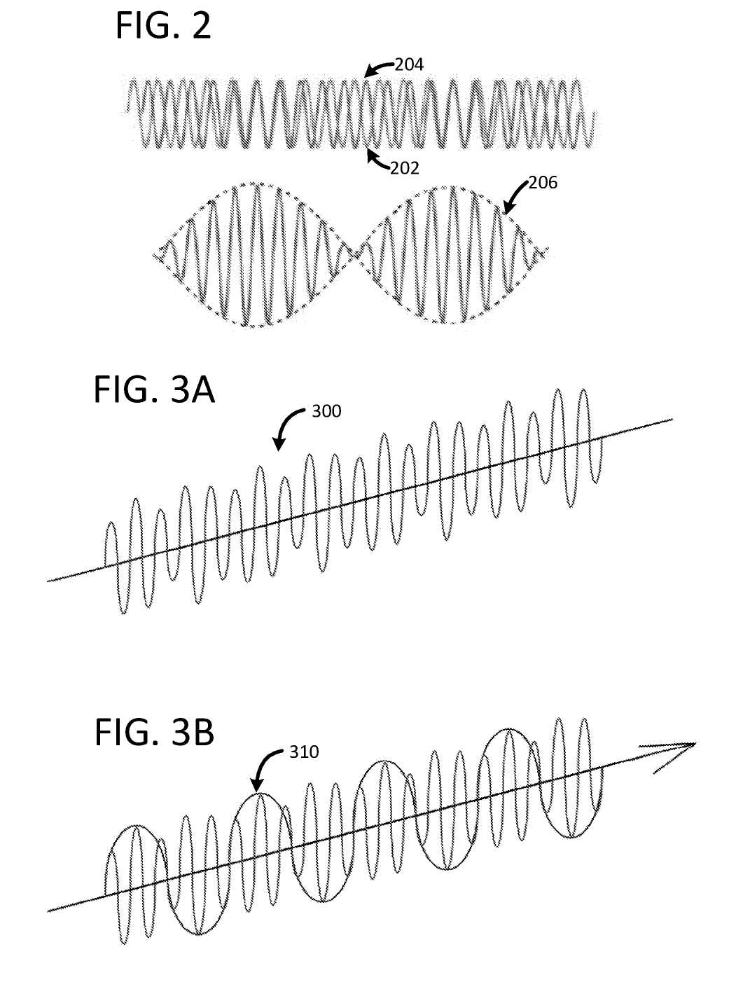

When a metal structure is being excited by a vibrator whose speed is being slowly increased, swept, and/or scanned such that the vibration frequency approaches the structure's resonance or to any other frequency that is externally applied to the structure, for example, as the resonance peak and frequency are approached, prior to a sub-resonant condition, an audible sensation not unlike a beat-frequency can be heard. A beat-frequency is the difference frequency between two waves of nearly identical frequency. The “beat” of the frequency is caused by alternating between canceling and reinforcing of wave amplitude as the waves go out-of-phase or in-phase. Audibly it sounds like a form of warbling or a series of short loud and soft sounds of the same pitch. The waveform shown in FIG. 2 illustrates both the high-frequency components, for example, one being the vibrator frequency 202, the other the weldment's resonant frequency 204 (or a frequency of a second vibrator), and the low-frequency or beat-frequency 206.

As resonance (or harmonic) is reached, the audible volume increases while the rate of warbling frequency decreases, becoming zero at resonance (or harmonic). If the vibration frequency continues to increase, the resonance (or harmonic) frequency is passed through, and the beat-frequency, warbling starts again, increasing in frequency, but dissipating in amplitude as the vibration frequency becomes too high with the weldment for resonance to occur.

Vibration normally travels through metal objects, referred to as traveling waves, at the speed associated with the metal involved. However, this is not true when a resonance or harmonic is being approached. There are at least two benefits of using a low-frequency traveling wave during 3D-VDW. First, a low frequency traveling wave is more likely to stir, blend, excite, or “slosh” the molten weld puddle. Second, the “on-again-off-again” pattern of a slow-moving traveling wave, together with the variations in both force intensity and direction (vector) of the forces involved, generate a settling action upon the barely solid, newly forming/formed metal grains that are cohering at the bottom of the weld puddle, where freezing is a continuous process. If such settling occurs, the amount of weld shrinkage at that location is significantly reduced, most likely due to better compaction of the newly formed grains. Some shrinkage will always occur in the weld as a result of thermal expansion and contraction of the metal. The use of 3D-VDW, however, results in improved compaction of the freshly formed grains leaves less space between the grains, which minimizes shrinkage that is not a pure result of cooling. By reducing in size and population these millions of spaces, there is less space for these grains to rearrange during cooling, this rearranging being a primary cause of non-thermal weld shrinkage and resulting weld distortion.

This traveling wave can be generated by using sub-resonance as described above, but is difficult to maintain as the resonance changes due to changes in the weldment's resonant frequency caused by the welding process itself. This problem is avoid by using two vibrators tuned to two close, but not identical, frequencies that interact with each other. This is indeed the way that, for example, a beat-frequency is often first heard, e.g., by playing two adjacent keys on a piano. If the keys are held down after striking (or the pedals depressed) the warbling beat-frequency can be heard.

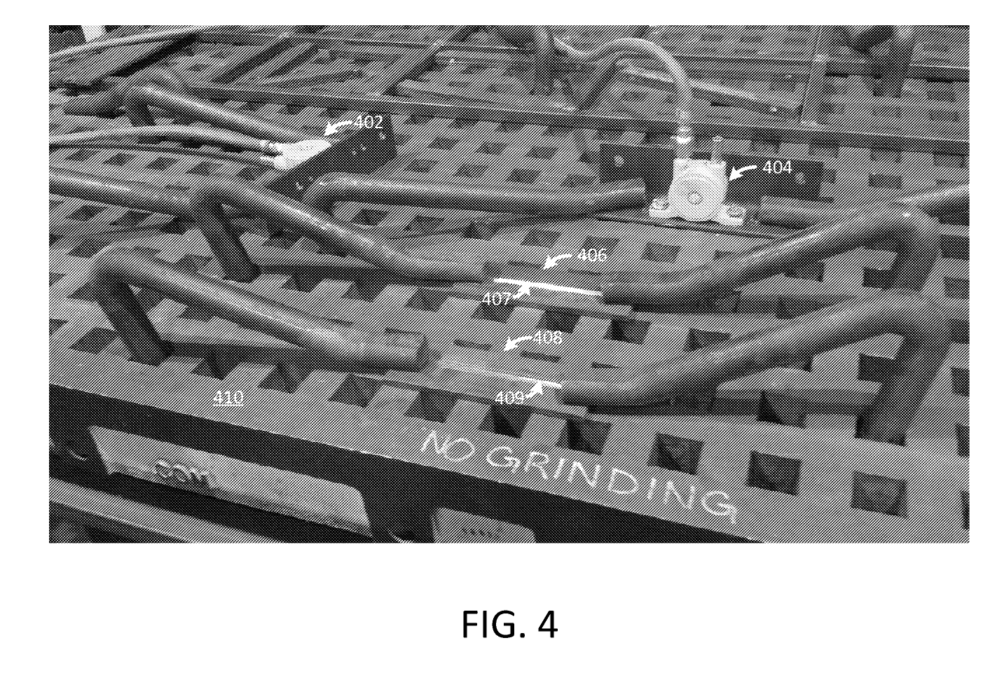

In one embodiment, two vibrators, tuned to similar, but not exactly the same speed/frequency (to produce similar but not identical frequencies) is employed. If the vibration frequencies coming from the two vibrators, each of which may be, for example, a simple sine wave, are roughly the same, but not identical, a third vibration frequency or beat frequency, which is the difference between the first and second frequency, is produced. An example of the waveforms generated by two vibrators, and how a low frequency traveling wave results, is illustrated in FIGS. 3A-B. FIG. 3A shows a combined waveform 300 generated from the summing of the vibration frequencies of two vibrators. The variations in amplitude due to the interference of the two wave forms cause a warbling beat frequency as the two waves sum to alternately cancel and reinforce each other. FIG. 3B shows the beat frequency that is generated by the combination of the two vibration frequencies of the two vibrators, effectively generating a third frequency 310. Because the two vibration frequencies are not the same, the third frequency 310 travels down the weldment as a slow-moving traveling wave and is equal to the difference between the first and second frequencies, subjecting the weld puddle to vibrations at continuous variations in both force amplitude and direction. The closer the two vibrator frequencies are to each other, the lower the frequency and speed of the traveling wave. The arrow points to the direction of travel of the traveling wave in FIG. 3B. The frequencies selected for the first and second frequencies can be any practical vibration frequency, which may be dependent on the particular vibrator used. Preferably, the two frequencies will be within 5% of each other. For example, if a first frequency is 8000 revolutions per minute (RPM) and a second frequency is 8400 RPM, the third frequency would be 400 RPM which is within 5% of both frequencies.

Another advantage of using two vibrators is to overcome another shortcoming of older VDW systems which is their two dimensional output. For example, a rotating device has force output in a plane perpendicular to the axis of rotation (AOR). But welding can take place in any direction in a structure, and weld shrinkage is a three dimensional phenomenon. If two vibrators are used, then this shortcoming of having only two dimensional output can be addressed by orienting the vibrators' AOR's, and their force output, in different directions.

By using two vibrators tuned to similar, but not identical speeds, and having different orientations, a three dimensional force-field wave form with beat-frequency characteristics, ideal for compacting freshly created metal grains that are forming at the bottom of a weld puddle, can be produced. The resulting reduction in distortion in the weldment caused by the weld is more pronounced than other methods, for the reasons described. In addition, the process and system does not require the near-constant adjustment in vibrator speed that the single vibrator sub-resonance approach requires, and thus the resulting weld is more consistent, repeatable and the system and process is much more practical, due to its ease of use.

Furthermore, the sub-resonance approach suffers also from limited area of influence. The vibration has a limited distance range where it is effective. By using two or more vibrators, this area of influence can be greatly expanded, allowing the welder(s) to concentrate on their chief task: welding.

An example that illustrates the importance of reducing weld distortion is the construction of log box beams for use in hydraulic drilling rigs and systems. These beams are roughly 20 by 30 inches in cross-section, and may be as much as 52 feet long. They are made out of ⅜″ and ½″ HY80 high-tensile alloy steel plate, a high strength, low alloy (HSLA) steel, developed originally for use as submarine hull material. This steel is very strong material, having more than twice the strength of mild steel, and thus is difficult to straighten if welding distortion occurs.

Dimensional tolerances for these tubes as welded may be +/−0.25 inches over the full length. To achieve this tolerance, welders would previously have to compensate for the impending distortion by “back-bending” the individual plates before fastening them together. By bowing or bending the plates first, the weld distortion that takes place during seam welding is compensated for. Even with back-bending, straightening of the weldment may still be required, but perhaps to a lesser degree than without the back-bending method. Back-bending is also time-consuming.

Back-bending does not work for higher tolerance applications. Using 3D-VDW, the beams can be welded straight within, for example, +/−0.09 inches over 50 feet, producing beams that can be made at lower tolerances. In addition, it has been discovered that a vibration intensity of between two and five times gravitational acceleration is a preferred intensity of vibration to minimize welding distortion. This vibration intensity can be measured with a portable vibration meter, for example meters capable of displaying a spectrum of the vibration frequency such as those made by Technical Products International.

### Example

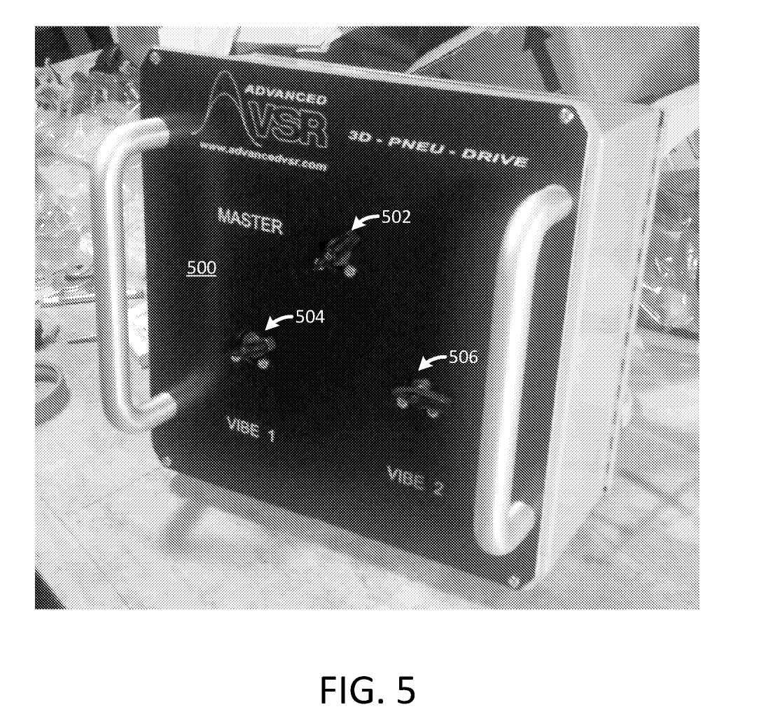

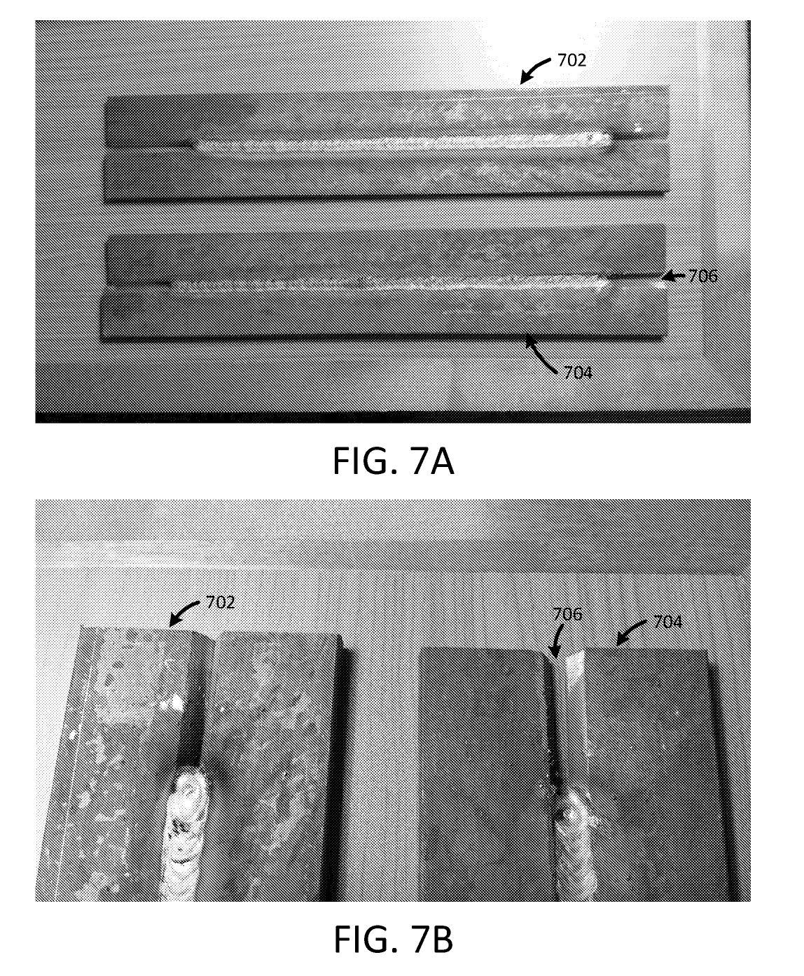

Shown in FIG. 4, two pneumatically powered vibrators, 402, 404, mounted in different orientations are used to perform VDW on the test coupons 406, 408 on a welding fixture 410. For example, vibrator 402 in FIG. 6 may be oriented such that the AOR of the pneumatic cam is in the vertical direction and orthogonal with respect to the line of the weld seams 407, 409 of the test coupons 406, 408. Thus, the force output direction of the vibrator 402 may be along a horizontal plane with respect to the welding fixture 410 and the line of the weld seams 407, 409. Vibrator 404 may be oriented such that the AOR of its pneumatic cam is in the horizontal direction and orthogonal with respect to the weld seam 407, 409 of the test coupons 406, 408. Thus, the force output direction of the vibrator 404 may be in a vertical plane with respect to the welding fixture 410 and orthogonal with respect to the line of the weld seams 407, 409. The vibration frequencies of the two vibrators 402, 404 may be selected to be near but not identical to each other so that together they generate a slow moving, low frequency traveling wave in the welding fixture 410 and the test coupons 406, 408 or any other weldment.

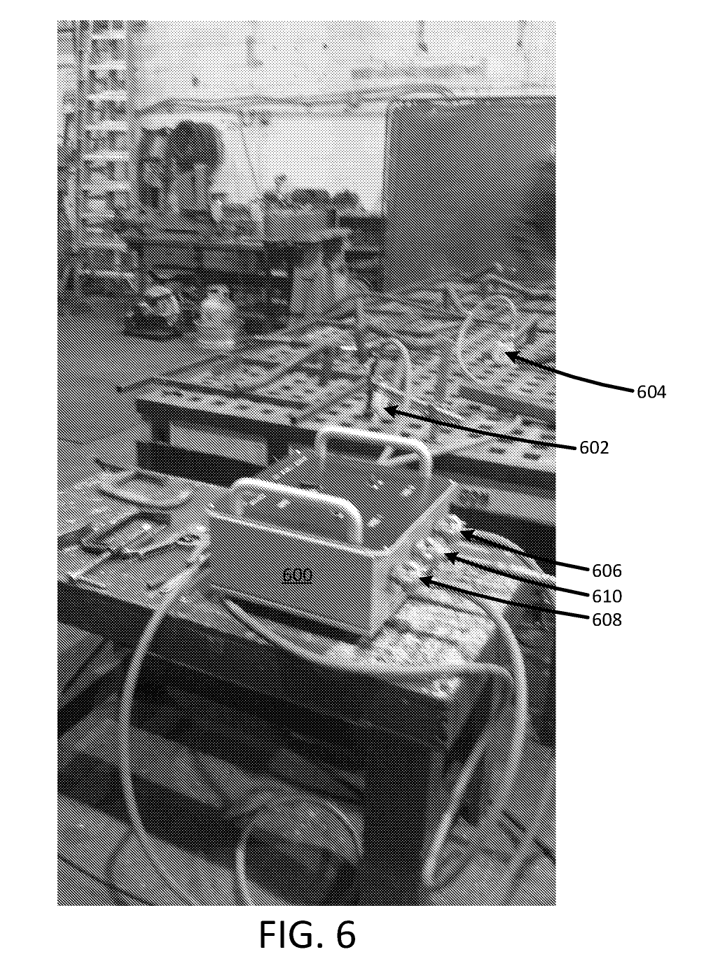

Referring now to FIG. 5, an example of a three-port control device 500 is provided. A master switch 502, and vibrator switches 504, 506 are shown. The master switch 502 controls the pneumatic master input. Vibrator switch 504 controls the pneumatic output for a first vibrator, for example vibrator 402. Vibrator switch 506 controls the pneumatic output for a second vibrator, for example vibrator 404. Thus, using the vibrator switches 504, 506, the vibration frequencies of the first and second vibrators may be variable and controlled independently. In some embodiments, the intensity of the air flow through the control device 500 is controlled by the switches 502, 504, 506. The master switch 502 controls total pneumatic output, e.g. adjusts the pneumatic output of both output ports proportionally. The vibrator switches 504, 506 can variably and independently control the intensity of the pneumatic output from the output port associated with that switch, e.g. adjusts the pneumatic output for one port individually and independently of the other output port. Referring to FIG. 6, the pneumatic control device the pneumatic may be installed to control, for example, the vibrators 402, 404 of the welding set up illustrated in FIG. 4. In FIG. 6, the connections are shown between the pneumatic control panel 600 and the pneumatic vibrators 602, 604 via pneumatic ports 606, 608. Pneumatic control panel 600 also includes pneumatic input port 610 connected to an air compressor (not shown).

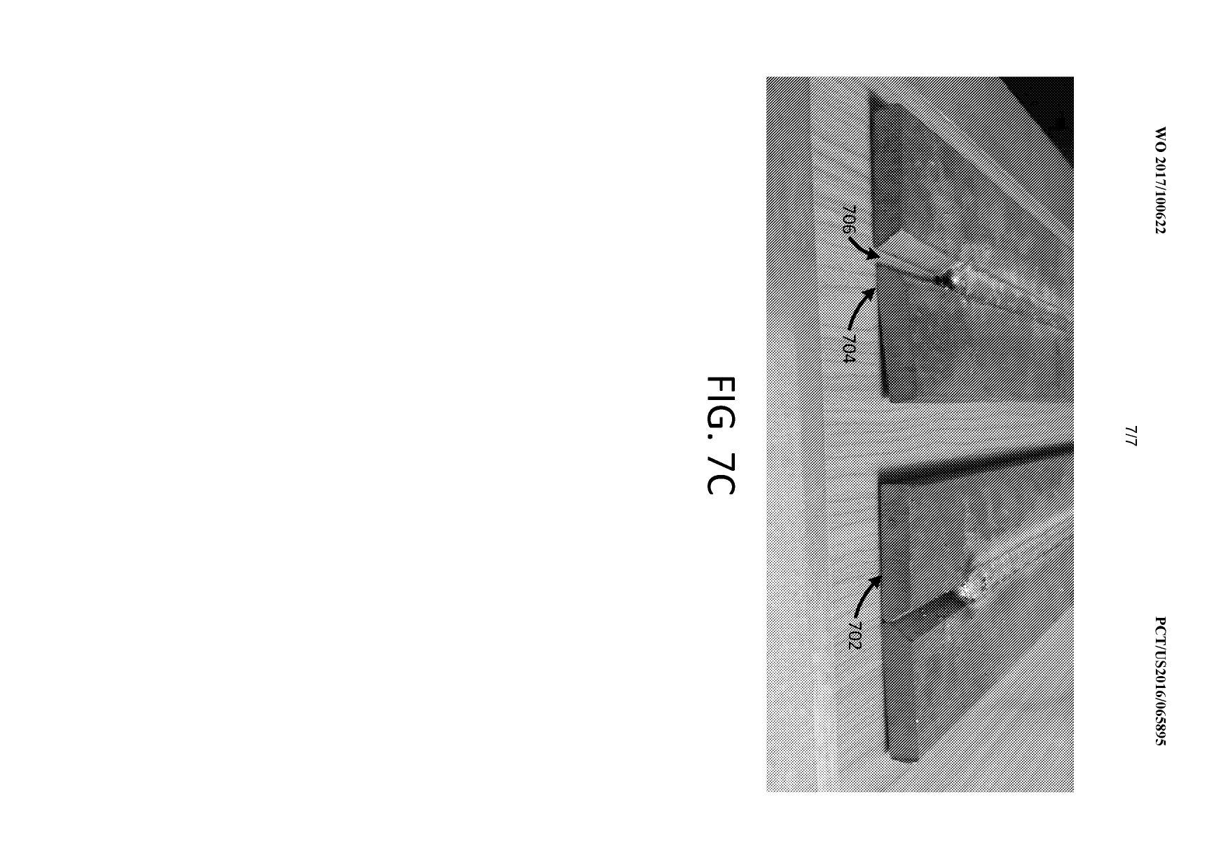

Referring to FIGS. 7A-C, various aspects of the welded test coupons, for example test coupons 406, 408 from FIG. 4, are shown. Welded coupons 702 were welded using VDW as described herein, while welded coupons 704 were welded using a conventional welding technique (with no vibration). The conventionally produced welded coupon 704 exhibits distortion in the form of a gap 706 between the weldments. Welded coupon 702 exhibits negligible distortion. The only difference between the two welded coupons is the application (or absence) of VDW.

It will be clear that the various features of the foregoing systems and/or methodologies may be combined in any way, creating a plurality of combinations from the descriptions presented above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. All references cited herein are incorporated by reference in their entirety. Citation of any patent or non-patent references does not constitute admission of prior art.

Those skilled in the art will recognize that the disclosed method has many applications, may be implemented in various manners and, as such is not to be limited by the foregoing embodiments and examples. Any number of the features and methods of the different embodiments described herein may be combined into a single embodiment. The locations of particular elements may be altered. Alternate embodiments are possible that have features in addition to those described herein or may have less than all the features described. Functionality may also be, in whole or in part, distributed among multiple components, in manners now known or to become known.

It will be appreciated by those skilled in the art that changes could be made to the embodiments described above without departing from the broad inventive concept. It is understood, therefore, that this invention is not limited to the particular embodiments disclosed, but it is intended to cover modifications within the spirit and scope of the invention. While fundamental features of the invention have been shown and described in exemplary embodiments, it will be understood that omissions, substitutions, and changes in the form and details of the disclosed embodiments may be made by those skilled in the art without departing from the spirit of the invention. Moreover, the scope of the invention covers conventionally known, and future-developed variations and modifications to the components described herein as would be understood by those skilled in the art.

In the claims, the term “comprises/comprising” does not exclude the presence of other elements, features, or steps. Furthermore, although individually listed, a plurality of means, elements, or method steps may be implemented by, e.g., a single unit, element, or piece. Additionally, although individual features may be included in different claims, these may advantageously be combined, and their inclusion individually in different claims does not imply that a combination of features is not feasible and/or advantageous. In addition, singular references do not exclude a plurality. The terms “a”, “an”, “first”, “second”, etc., do not preclude a plurality. Reference signs or characters in the disclosure and/or claims are provided merely as a clarifying example and shall not be construed as limiting the scope of the claims in any way.

The foregoing description has broad application. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

1. A method for minimizing weld distortion in a weldment, the method comprising:
applying a first vibration frequency in a first force direction to a weldment or a welding fixture to which the weldment is attached;
applying a second vibration frequency in a second force direction to the weldment or the welding fixture to which the weldment is attached, wherein the first and second vibration frequencies are selected to generate a third vibration frequency in the weldment or welding fixture;
welding the weldment along a weld seam.

2. The method according to claim 1, wherein the first and second vibration frequencies are selected to be near but not identical to each other.

3. The method according to claim 2, wherein third vibration frequency is a difference between the first and second frequencies causing a slow moving traveling wave in the weldment or welding fixture.

4. The method according to claim 1, further comprising:
applying the first vibration frequency using a first vibrator having a force output in a vertical relative to the weld seam; and
applying the second vibration frequency using a second vibrator having a force output in a horizontal plane relative to the weld seam.

5. The method according to claim 4, wherein the first and second vibrators are first and second pneumatic vibrators.

6. The method according to claim 4 further comprising independently varying the first vibration frequency so that it is near but not identical to the second vibration frequency.

7. The method according to claim 6, wherein the first and second pneumatic vibrators have an axis of rotation, the method further comprising:
orienting the first pneumatic vibrator so that its axis of rotation is in a first orthogonal direction with respect to the weld seam; and
orienting the second pneumatic vibrator so that its axis of rotation is in a second orthogonal direction with respect to the weld seam.

8. A system for minimizing weld distortion, the system comprising:
a pneumatic control device for controlling air flow, the control device having a first and second output each for providing an air flow output that are independently variable and independently controllable;
a first pneumatic vibrator attachable to a weldment or welding fixture and connectable to the first output of the pneumatic control device, wherein the first vibrator is independently controllable using the control device so that the first vibrator vibrates at a first vibration frequency based on the air flow output of the first output; and
a second pneumatic vibrator attachable to a weldment or welding fixture and connectable to the second output of the pneumatic control device, wherein the second vibrator is independently controllable using the control device so that the second vibrator vibrates at a second vibration frequency based on the air flow output of the first output.

9. The system according to claim 8, wherein the first pneumatic vibrator and the second pneumatic vibrator are arranged so that a first force direction of the first pneumatic vibrator is different than a second force direction of the second pneumatic vibrator.

10. The system according to claim 9, wherein the first and second pneumatic vibrators have an axis of rotation, and wherein the first pneumatic vibrator is arranged so that its axis of rotation is in a first orthogonal direction with respect to a weld seam of a weldment, and wherein the second pneumatic vibrator is arranged so that its axis of rotation is in a second orthogonal direction with respect to the weld seam of the weldment.

11. The system according to claim 8, wherein the first and second vibration frequencies are selected to generate a third vibration frequency in the weldment or welding fixture.

12. The system according to claim 8, wherein the first and second outputs are configurable to output first and second vibration frequencies that are near but not identical to each other.

13. The system according to claim 12, wherein the first and second frequencies produce a third vibration frequency which is equal to the difference between the first and second frequencies causing a slow moving traveling wave in the weldment or welding fixture.

14. The system according to claim 8 further comprising an air compressor connectable to an input on the control device.

15. A pneumatic control device used to reduce distortion during welding, the pneumatic control device comprising:
a master input port configured to accept a connection to an air compressor;
a first output port configurable to connect to a first pneumatic vibrator;
a second output port configurable to connect to a second pneumatic vibrator;
a plurality of selectable controls that independently controls pneumatic input from the master input port and pneumatic output to each of the first and second output ports such that the selectable control interface includes:
a first setting to cause an output to the first output port sufficient to cause a first pneumatic vibrator to vibrate at a first vibration frequency,
a second setting to cause an output to the second output port sufficient to cause a second pneumatic vibrator to vibrate at a second vibration frequency, and
a master setting that controls input from the air compressor.

16. The pneumatic control device according to claim 15, wherein the first and second settings are configurable so that the first and second vibration frequencies are near but not identical to each other.

17. The pneumatic control device, according to claim 16, wherein the first and second settings are selected to cause the first and second vibrators to generate a third vibration frequency in a weldment or welding fixture.

18. The pneumatic control device according to claim 17, wherein third vibration frequency is a difference between the first and second frequencies causing a slow moving traveling wave in the weldment or welding fixture.
